(19) United States
(12) Patent Application Publication
(10) Pub. No.: US 2008/0290122 A1
(43) Pub. Date: Nov. 27, 2008

(54) Handicap parking permit holder

(76) Inventor: Paul D. Jones, Lansing, MI (US)

Correspondence Address: JAMES RAY & ASSOCIATES, 2640 PITCAIRN ROAD, mONROEVILLE, PA, 15146, US

(21) Appl. No.: 12/072,273

(22) Filed: Feb. 25, 2008

Related U.S. Application Data
(60) Provisional application No. 60/939,496, filed on May 22, 2007.

(51) Int. Cl. B60R 7/05

(52) U.S. Cl. 224/312

(57) ABSTRACT

An apparatus for storing and displaying a handicap parking permit as well as other parking tags on a vehicle. The apparatus comprises a holder member having each of a predetermined shape and a predetermined size and formed of a predetermined material. A pivoting clip member is engageable with a top portion of the holder member and there is a means for securing the pivoting clip member to a vehicle's sun visor.

### CROSS REFERENCE TO RELATED APPLICATIONS

This application is closely related to and claims benefit from U.S. Provisional Application Ser. No. 60/939,496 filed May 22, 2008.

### FIELD OF THE INVENTION

The present invention relates, in general, to a holder for a permit, and, more particularly, the present invention relates to a permit holder for use in an automobile for holding a handicap parking permit or a regular hanging parking permit.

### BACKGROUND OF THE INVENTION

Currently, handicap parking permits, as well as other parking tags, are hung from the vehicle's rear view mirror. They can be easily blown off when a strong gust of wind enters the car or can fall off and end up on the floor of the vehicle when the car door is shut. Also, since the law requires that the tag or permit has to be removed prior to driving for safety reasons, the constant act of hanging and removing it can cause wear and tear on the permit. Because of the annoyance of removing and repositioning the permit every time the car is driven many drivers tend to disobey the law and leave the permit hanging on the rearview mirror. The major problem with this is that it is an impediment to the vison of the driver and could possible be the cause of an accident.

Thus, it would be advantageous if there were a means for leaving the parking permit in place and yet no present a problem with the vision of the driver.

### SUMMARY OF THE INVENTION

In a first aspect the present invention provides an apparatus for storing and displaying a handicap parking permit as well as other parking tags on a vehicle. The apparatus comprises a holder member having each of a predetermined shape and a predetermined size and formed of a predetermined material. A pivoting clip member is engageable with a top portion of the holder member and there is a means for securing the pivoting clip member to a vehicle's sun visor.

### OBJECTS OF THE INVENTION

It is, therefore, one of the primary objects of the present invention to provide a holder for storing and displaying a handicap parking permit.

Another object of the present invention is to provide a holder for such parking permit in which the holder with the permit inside is merely turned upward and lies flush against the sun visor while the vehicle is being driven.

Still another object of the present invention is to provide a holder that is mounted on a pivoting clip member so that when such vehicle is parked the holder can be pivoted and thereby turned downward so as to be clearly visible.

Yet another object of the present invention is to provide a holder for such parking permit that is transparent.

Another object of the present invention is to provide a holder member in which the parking permit merely slides into the holder.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a front view of the apparatus with a handicap parking permit partially slid into the holder according to an embodiment of the invention.

FIG. 2 is a front perspective view of the apparatus shown in FIG. 1 attached to a car's visor and hanging downward as would be when a vehicle is parked.

FIG. 3 is a side perspective view of the apparatus with the holder pivoted so as to lie flush against the visor as would be the case when the vehicle is being driven.

FIG. 4 is a side view of the apparatus with the holder positioned against the visor and showing the pivoting member attached to the visor.

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for storing and displaying a handicap parking permit 2 as well as other parking tags on a vehicle. The apparatus 10 comprises a holder member 4 having each of a predetermined shape and a predetermined size and formed of a predetermined material. A pivoting clip member 6 is engageable with a top portion of the holder member 4 and there is a means 8 for securing the pivoting clip member 6 to a vehicle's sun visor 14.

The means 8 for securing the pivoting clip member 6 is generally a U-shaped clip 12 that fits over a width portion of such sun visor. Such pivoting clip member 6 permits the holder member 4 to be rotated downwards so that such parking permit 2 is readily visible when such vehicle is parked and rotated upwards so that the holder 4 is placed flush against such visor 14 prior to driving so as to not block a driver's vision.

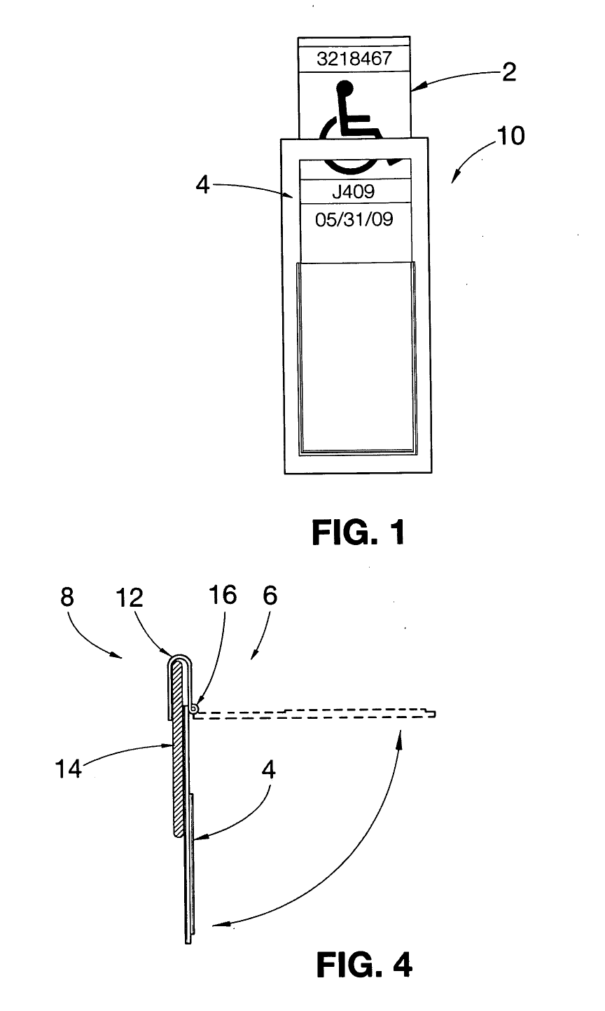

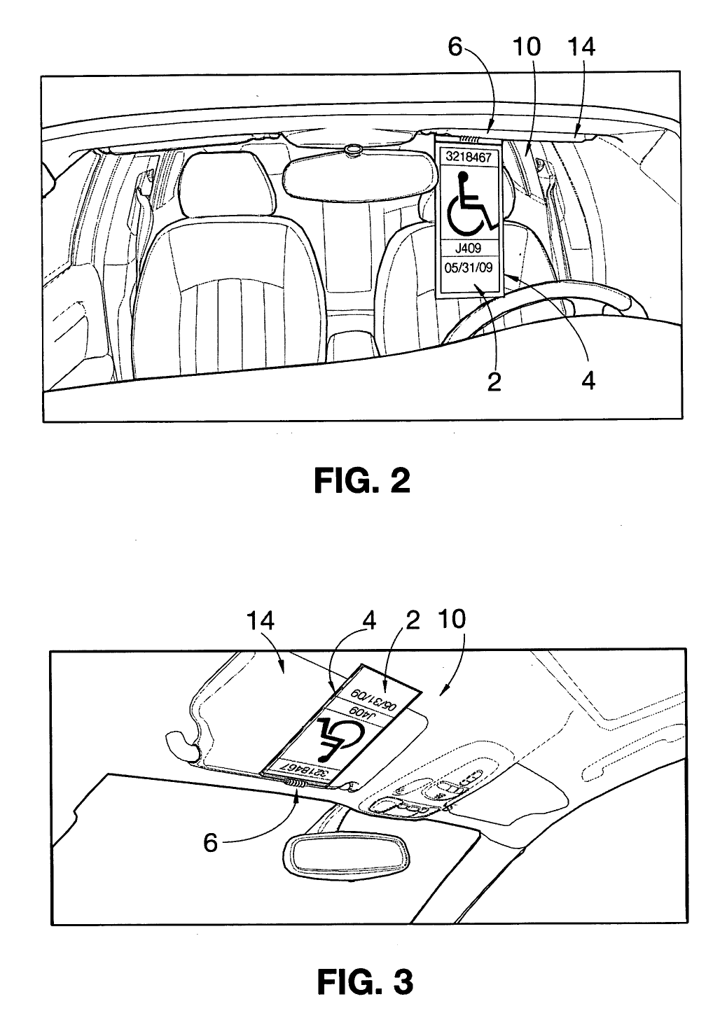

Such holder member 4 has one of an opening in a top of the holder member 4 or an opening in a side of the holder member 4 for placing such parking permit 2 in holder member 4. It is presently preferred that such holder member 4 have an opening in a top of the holder member 4 as is seen in FIG. 1.

It is also presently preferred that the predetermined material for forming such holder member 4 is plastic and, further, that such plastic is a heat-resistant plastic. It is also preferred that at least the front portion of the holder member 4 be a transparent plastic and even more preferred that both sides of the holder member 4 are transparent.

The predetermined size of such holder member 4 is between about 9 and ⅜ inches and 9⅝ inches in length and about 3⅞ and 4⅛ inches in width which is sufficient to hold a handicap parking permit 2.

Such holder member can be engageable with either the driver's sun visor 14 or the passenger's sun visor 14 depending on the preference of the driver.

Thus, the present invention provides an apparatus that is used for storing and displaying a handicap parking permit. The holder is constructed of a heat-resistant plastic. The permit holder measures approximately 9½ inches long and 4 inches wide which is sufficient for holding the handicap permit. At least a front side of the holder is transparent so that the permit is readily visible. The top of the holder has a pivoting clip that attaches on one end to the visor of a vehicle. The pivoting clip has a clip portion that merely slides on to the visor and secures the holder. The parking permit is merely slid into the holder into the top of the holder. The holder can be rotated downward when the vehicle is parked and then rotated upwardly flush against the visor prior to the vehicle being driven. The use of the holder can prevent the driver from forgetting to remove the tag before driving and provides a more efficient means of displaying the permit when needed. This also eliminates the need to search for the tag when parking as the permit will always be in the same place and merely needs to be rotated so it is visible. The holder is useful for all drivers that have been issued a handicap permit as well as for those whose home, school or workplace have parking conditions that require prominent display of a parking pass. Since by law the permit has to be removed prior to driving for safety reasons, the constant act of removing and hanging the permit can cause excessive wear and tear on the permit.

Such pivoting clip member 6 is formed with the U-shaped clip 12 is attached to one portion of a base portion 16 of the pivoting clip member 6 and the pivoting portion 18 attached to another portion of the base member 18 and to the holder member 4.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for storing and displaying a handicap parking permit and other parking passes on a vehicle, said apparatus comprising:
(a) a holder member having each of a predetermined shape and a predetermined size and formed of a predetermined material,
(b) a pivoting clip member engageable with a top portion of said holder member; and
(c) a means for securing said pivoting clip member to a vehicle's sun visor.

2. The apparatus, according to claim 1, wherein said means for securing said pivoting clip member is generally a U-shaped clip that fits over a width portion of such sun visor.

3. The apparatus, according to claim 2, wherein said pivoting clip member permits said holder member to be rotated downwards so that such permit is readily visible when such vehicle is parked and rotated upwards so that said holder is placed flush against such visor prior to driving so as to not block a driver's vision.

4. The apparatus, according to claim 1, wherein said holder member has one of an opening in a top of said holder and an opening in a side of said holder member for placing such parking permit in said holder member.

5. The apparatus, according to claim 4, wherein said holder member has an opening in a top of said holder member.

6. The apparatus, according to claim 1, wherein said predetermined material for forming said holder member is plastic.

7. The apparatus, according to claim 6, wherein said plastic is heat-resistant.

8. The apparatus, according to claim 1, wherein at least a front portion of said holder member is transparent.

9. The apparatus, according to claim 8, wherein both sides of said holder member are transparent.

10. The apparatus, according to claim 1, wherein said predetermined size is between about 9 and ⅜ inches and 9⅝ inches in length and about 3⅞ and 4⅛ inches in width.

11. The apparatus, according to claim 1, wherein said apparatus is engageable with one of a driver's sun visor and a passenger's sun visor.

12. The apparatus, according to claim 2, wherein said pivoting clip member further includes a base portion for connecting said U-shaped clip member with said pivoting clip member.
